(19) United States
(12) Patent Application Publication
(10) Pub. No.: US 2010/0139019 A1
(43) Pub. Date: Jun. 10, 2010

(54) Cleaning Apparatus for Large Diameter Pipe

(76) Inventors: Christian Geppert, Homburg (DE); Stefan Schroth, Offenbach (DE)

Correspondence Address: TIM COOK, P.O. BOX 10107, LIBERTY, TX, 77575, US

(21) Appl. No.: 12/597,770

(22) PCT Filed: Apr. 28, 2008
(86) PCT No.: PCT/IB08/03070

§ 371 Date: Oct. 27, 2009

Related U.S. Application Data
(60) Provisional application No. 60/914,434, filed on Apr. 27, 2007.

(51) Int. Cl. B08B 9/04

(52) U.S. Cl. 15/104.061

(57) ABSTRACT

Apparatus for cleaning the interior surfaces of large diameter pipe provides a lightweight basic structure that is easily adapted to clean a range of diameters of pipe. The apparatus uses an interlocked drive mechanism to develop axial movement of the device and synchronize the rotary movement of the cleaning nozzles. The rate of movement is adjustable, to accommodate pipe of varying diameters. That way, the cleaning spray covers a swath of pipe surface, with a minimum overlap between passes, with no gaps in the cleaning.

### FIELD OF THE INVENTION

The present invention relates generally to the field of cleaning apparatus for large diameter pipes and, more particularly, to such an apparatus which uses a basic structure for cleaning pipes, but which is modularly expandable for use within a wide range of diameters of pipes. The present invention further relates to a self propelled pipe cleaning system which automatically synchronizes the axial rate of movement of the system with the rate of movement of a plurality of spray nozzles to ensure complete cleaning of the interior surface of a pipe at the maximum rate of travel.

### BACKGROUND OF THE INVENTION

Pipelines used in hydroelectric power generation applications and many other types of applications suffer from known fouling mechanisms. Over time, deposits build up on the interior walls of pipes, thereby degrading the operational effectiveness of the pipeline. Pipelines also experience corrosion and erosion, which may also call for periodic maintenance on the interior surfaces of the pipe.

Many types of cleaning apparatus have been used in the past for cleaning pipes of relatively small diameter. One example of such a cleaning apparatus is a pipeline pig forced through the pipe under hydraulic pressure. Other apparatus includes lancing crawlers that are manually drawn through the pipe by a guide wire. However, as the diameters of pipes become larger, these types of cleaning systems become impractical. Thus, typical cleaning methods in use today for large diameter pipes include the use of hand-held lances and water-jet nozzles to clean debris from pipe walls. This method of cleaning pipe is expensive, labor intensive, dangerous, time consuming, and often of poor quality.

For an automatic (i.e. un-manned) cleaning system in use today, the coordination of the rate of advance of the system (axial rate of traverse) is very difficult. Most such systems use a manual system to move the cleaning apparatus through the pipe, such as for example on a wireline. To accommodate the difficulty of synchronizing the axial movement of the cleaning apparatus with the rotary movement of the jets, many systems use rapidly rotating nozzles to sweep a wide swath of the pipe wall interior. Then, as the system moves along the pipe, a wide area of overlap is required to ensure that all of the inside wall of the pipe is cleaned. This results in very inefficient cleaning since areas of the wall surface have to be traversed multiple times.

Another drawback of systems in use today is that systems are often tailored to a specific large job. Then, if a larger pipe is to be cleaned using the same design, all of the dimensions of the system must be scaled up to accommodate the larger pipe. Eventually, the size and weight of the system becomes prohibitive, and the operator then reverts to the previously described manual cleaning method.

For large pipes with a steep angle, such as for instance for hydraulic power stations, the weight of a conventional wagon which carries the cleaning apparatus is much too high for winding the wireline on a capstan with precision as required by the water-jet nozzles to attain 100% cleaning effectiveness. So, the solution up to now has been either to perform an incomplete cleaning job with additional, follow-on cleaning by hand or to install multiple cleaning heads with several nozzles, which rotate at the end of a radial lever close to the pipe wall and the lever rotating more or less around the pipe axis. This latter configuration, i.e. multiple cleaning heads with a plurality of nozzles, consumes an enormous volume of high pressure water and is grossly inefficient.

In using typical systems in the current art, it is nearly impossible to achieve a predetermined constant advance speed for the equipment in an inclined pipe, such as for example large diameter pipes which feed large water turbines. Even when using a constant speed winch for pulling the apparatus upwards through the pipe, it is impossible to achieve constant transit speed at the apparatus itself. The elasticity of the wire rope between winch and apparatus gives the wire rope the behavior of a spring, which combined with the stick-slip effect of the elastic high pressure hoses connected to the apparatus, develops unacceptable variations in the forward speed of the apparatus. These variations in transit speed of the apparatus result in areas which are not cleaned properly, therefore making it necessary to do a second cleaning by hand with high pressure lances. Though a winch is helpful for safety reasons to secure the equipment in an inclined pipe, it does not provide a continuous and steady advance of the cleaning apparatus in relation to the rotational speed of the cleaning nozzles around the axis of the apparatus.

As previously described, as an operational system is adapted for use in larger and larger diameter pipes, the system is typically scaled up in all dimensions, meaning the chassis, the drive mechanism, and the lancing element are all made larger to accommodate the larger diameter pipe. This results in a geometric increase in the weight of the device. Thus, there remains a need for a system which can be adapted to larger diameter pipes with only an incremental increase in the weight of the device.

### SUMMARY OF THE INVENTION

The present invention addresses these and other shortcomings in the art of apparatus for cleaning the interior surfaces of large diameter pipe by providing a lightweight basic structure that is easily adapted to clean a range of diameters of pipe. An exchangeable set of structural components retains expandable arms which provide friction drive at the interior surface of the pipe, while simultaneously centering the device along the axis of the pipe.

The device of the present invention also uses an interlocked drive mechanism to develop axial movement of the device and synchronize the rotary movement of the cleaning nozzles. The rate of movement is adjustable, to accommodate pipe of varying diameters. That way, the cleaning spray covers a swath of pipe surface, with a minimum overlap between passes, with no gaps in the cleaning. Further, while it is beneficial for the support apparatus to be self-propelled, so that the rate of advance of the device may be synchronized with the rotation of the cleaning heads, it may also be beneficial to provide a winch at the top of the pipe, coupled to the device, to exert a predetermined tension on the device, independent of the speed of the cleaning apparatus. Such an added motive force coupled to the cleaning device takes a part of the weight of the cleaning apparatus and of the feeding hoses, thereby providing added support to the machine against gravity. This helps to maintain the expanding forces for the supporting wheels in reasonable limits, as it is the friction between supporting wheels and the wall of the pipe which enables for a steady advance speed. This feature also provides a safety aspect for the equipment as such a winch can have a worm gear or locking mechanism that blocks the cleaning apparatus from sliding backwards if adhesion is lost between the pipe wall and the driving wheels.

The device may also include a blocker device integrated into the design of the hoist cable with a stationary cable running under the device through the blocking device during the job. This stationary cable (such as for example ¼″ diameter wire rope) is laid into the pipe prior to the job. This blocker device preferably keeps the apparatus from sliding backwards in case of loosing adhesion to the wall. The device may comprise a jamb-lock which allows ease of motion of the device up the pipe, while preventing the device from moving back down the pipe.

The device of this invention is also modularized so that it can be placed through a man-hole cover on a large pipe and quickly and easily assembled in situ.

Thus, it is an object of the invention to create a cleaning apparatus, which drives itself even at steep angles along large pipes with an advance speed, which covers accuracy as needed for single water-jet nozzles, which should rotate around the pipe axis.

It is a further object of the invention to maintain the rotational axis of the water-jet nozzles on the axis of the pipe independently of changes in diameter of the pipe.

It is yet another object of the invention to create a cleaning apparatus for large pipes, which overcomes obstacles in pipes like heads of nuts, overlap of pipe walls, pipe bends and inaccuracies in pipe diameter.

It is a further object of the invention to have a modular arrangement, which makes it easy to use the same nozzles, wheels, motors and suspensions for jobs with different diameters and to only exchange the mounting structure and flexible tubes for water and compressed air.

These and other features and advantages of this invention will be readily apparent to those skilled in the art.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a side view of a cleaning apparatus of this invention, shown within a pipe during a cleaning operation.

FIG. 2 is an end view of the apparatus of FIG. 1.

FIG. 3 is a detail view of a drive wheel, in partial section, taken along section lines 3-3 of FIG. 1.

FIG. 4 is a detail view of a drive wheel, in partial section, taken along section lines 4-4 of FIG. 3.

FIG. 5 is a detail view of the mechanism that drives the rotation of spray arms for the cleaning apparatus.

FIG. 6 is a detail section view of a spray mechanism, taken along section lines 6-6 of FIG. 5.

FIG. 7 is a detail section view of a flexible drive coupling, taken along section lines 7-7 of FIG. 5.

FIG. 8 is a schematic representation of a positioning and centering system for the apparatus.

FIG. 9 is an end view of the apparatus with four positioning and centering arms at each end of the apparatus.

### DETAILED DESCRIPTION OF A PREFERRED EMBODIMENT

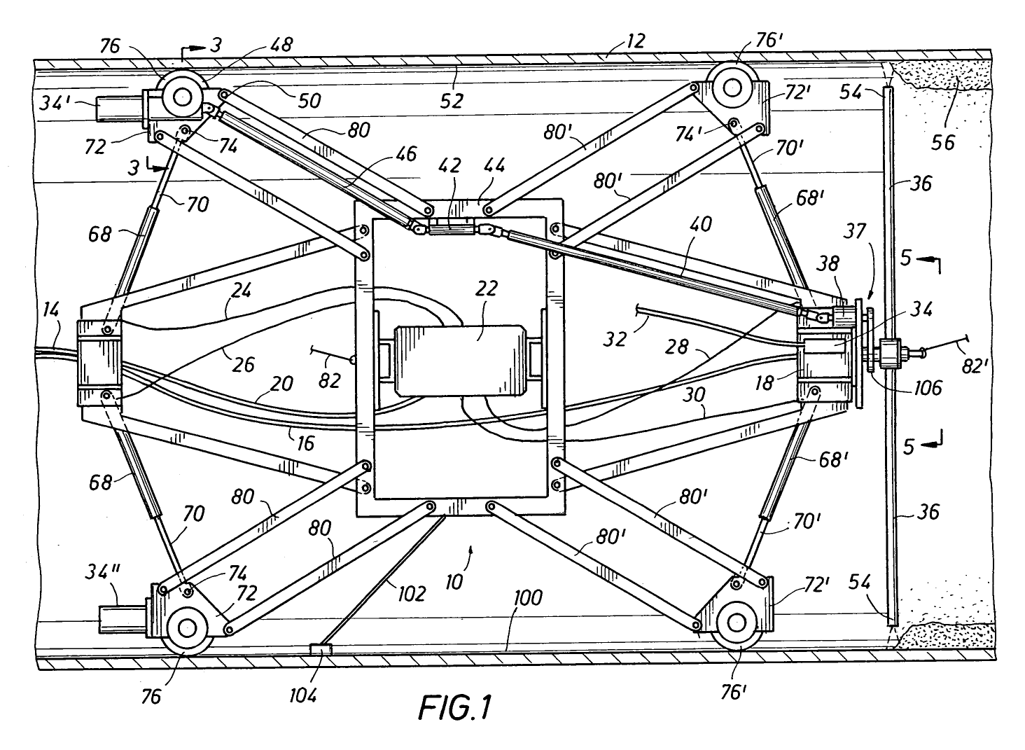

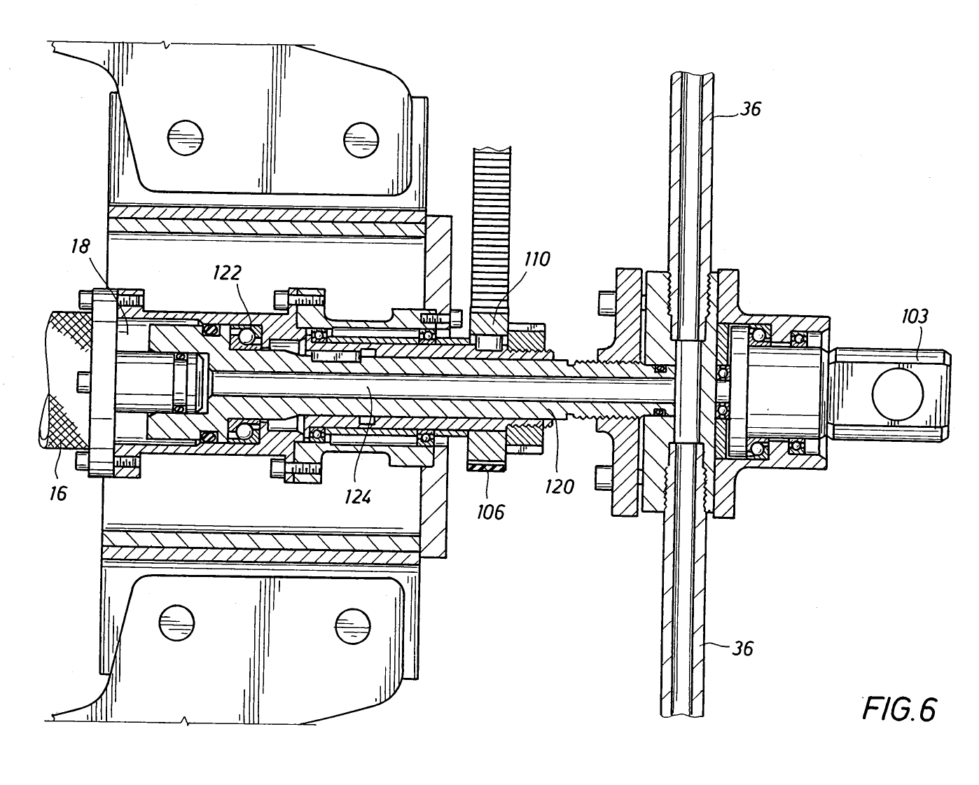

FIG. 1 illustrates a cleaning apparatus 10 of this invention in use in a pipe 12. The apparatus 10 is fed from a high pressure water source (not shown) via an umbilical 14. The umbilical 14 includes a high pressure water feed tube or hose 16 which feeds into the apparatus at a high pressure stationary coupling 18. The distribution of high pressure water is further described below in respect of FIG. 6.

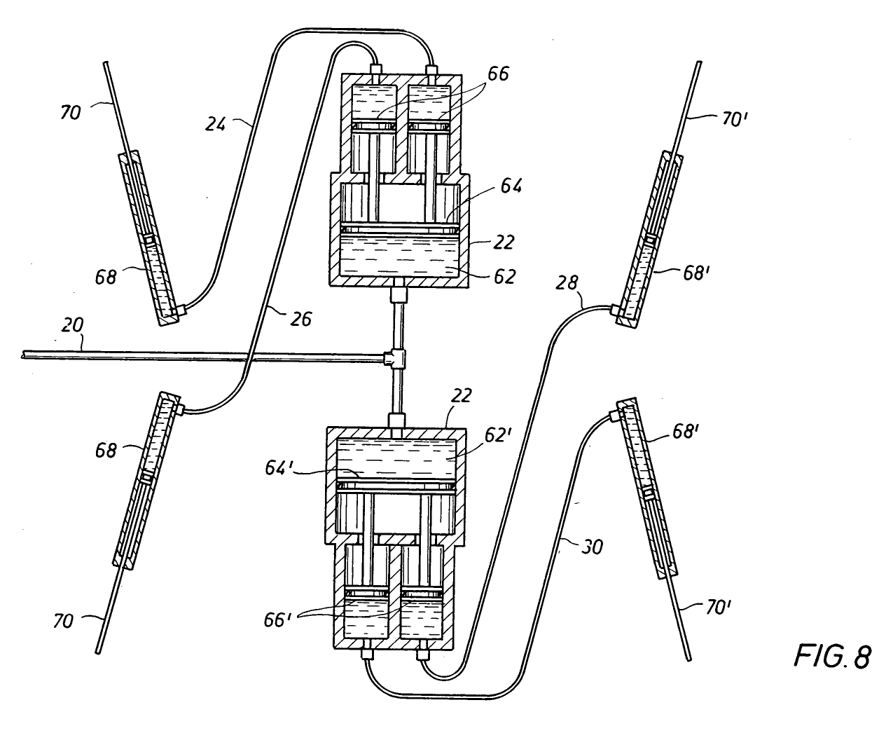

In addition to the high pressure water feed tube 16, the umbilical 14 also includes a feed tube 20 which supplies fluid under pressure to a distributor 22 for positioning and centering the apparatus in the pipe 12. Fluid under pressure is supplied by the distributor to supply lines 24 and 26 to the after end of the apparatus and to supply lines 28 and 30 to the forward end of the apparatus. The positioning and centering sub-system is shown and described below in greater detail in respect of FIG. 8.

A pneumatic supply line 32 provides pressurized air to an air motor 34. The air motor 34 creates rotary motion to drive a set of mutually opposed spray arms 36 through a set of gears 37. A drive coupling 38 is driven off the same set of gears and is coupled to a first drive shaft 40. The first drive shaft 40 is coupled to an idler shaft 42 mounted on a frame 44, and the idler shaft 42 drives a second drive shaft 46. The second drive shaft 46 drives a drive wheel 48 through a flexible U-joint 50. The drive wheel 48 contacts an inside surface 52 of the pipe 12 and thus the rate of motion of the apparatus parallel to the axis of the pipe is determined by the rate of the air motor 34. In that way, the drive rate of the drive wheel 48 is synchronized to the rate of rotation of the spray arms 36. For example, if one spray arm cleans a swath that is one inch wide, then the drive mechanism moves the apparatus slightly less that two inches (i.e. for two spray arms 36) for each rotation of the cleaning head, thereby providing 100% coverage for the cleaning spray with no wasted motion. The spray arms 36 terminate at spray nozzles 54 to remove rust and debris 56 from the interior surface of the pipe 12.

Alternatively, an air motor 34′ may be provided at the drive wheel 48. In that case, the mechanical energy is transmitted from the drive wheel 48 back through the drive shafts 46 and 40 in the opposite direction, but the structure and function are the same. If desired, another air motor 34″ may be provided, although the drive shafts from the air motor 34″ are omitted from FIG. 1 for ease of illustration.

In another preferred embodiment, a cardanic shaft may be coupled to the air motor 34 and secured at its opposite end to a bearing support member. Then, the cardanic shaft may be coupled to the first drive shaft 40 through a flexible belt drive, chain drive, direct gear engagement, or other mechanical coupling means. The cardanic shaft should preferably include a universal joint at each end to assist in alignment and to reduce stress.

The apparatus also includes a safely line 100, preferably a wire rope, which is tethered to the apparatus with a line 102 through a jam block 104. If the apparatus should start to slip, then the jam block closes down on the safely line 100, stopping the apparatus. Alternatively a safety line may be attached to a swivel joint 103 on the front of the apparatus (See FIG. 6).

At this point, it should be clear to those of skill in the art that many other ways may be chosen to provide the synchronization of the drive and the rotation of the cleaning head, such as a chain and sprocket arrangement, for example. Any such mechanical arrangement for synchronizing the linear motion and rotation of the cleaning head, equivalent to the structure herein described, is within the scope and spirit of this invention and the claims that follow.

Another difficulty overcome by the present invention relates to the problem of cleaning apparatus known in the art that are pulled through the pipe by a wireline. Such apparatus typically ride along the bottom surface of the pipe on carriage wheels, and thus the spray is not uniformly applied to the interior surface of the pipe. The, present invention, however, includes a mechanism for centering the apparatus along the centerline of the pipe, even when the diameter of the pipe changes. This will now be described in relation to FIGS. 1, 2, and 8.

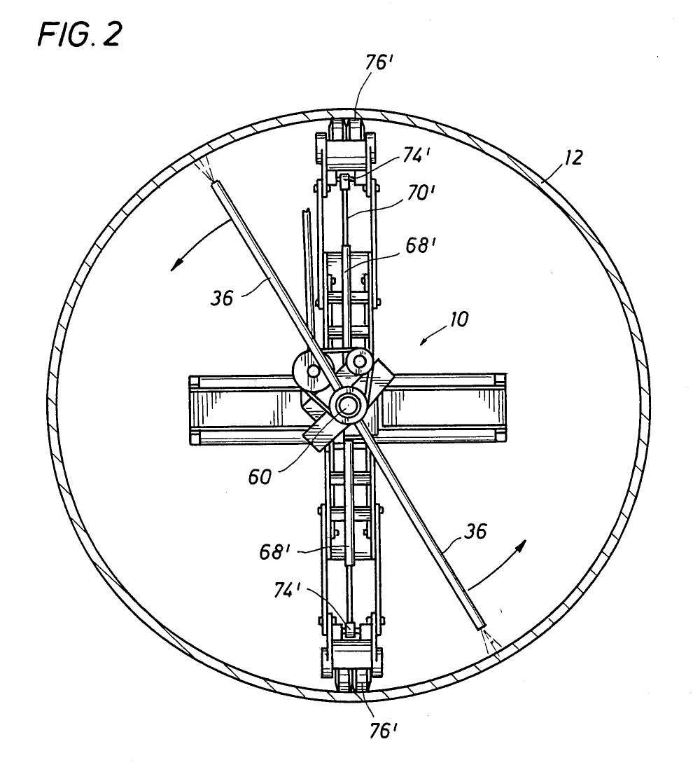

FIG. 2 shows the cleaning apparatus 10 within the pipe 12 as seen along an axis 60. The axis represents the axis of the apparatus 10 and the axis of the pipe, since they are co-axial. As previously described, the umbilical 14 supplies fluid under pressure to the distributor 22 for positioning and centering the apparatus in the pipe 12. Fluid under pressure is supplied by the distributor to the supply lines 24 and 26 to the after end of the apparatus and to supply lines 28 and 30 to the forward end of the apparatus. The distributor 22 is shown schematically in FIG. 8 as two separate cylinders for ease of illustration. Fluid under pressure enters the distributor 22 into a chamber 62 (for the after end of the device) and a chamber 62′ (for the forward end of the device), creating a force against a set of pistons 64 and 64′. Each of the pistons 64 and 64′ is coupled to a pair of secondary pistons 66 and 66′, respectively. Actuation of the pistons 66 and 66′ develops pressure in the supply lines 24, 26, 28, and 30. Hydraulic pressure is conducted into a set of cylinders 68 and 68′, thereby moving a set of piston rods 70 and 70′.

Each rod 70 and 70′ is attached to its respective bracket 72 and 72′ at a rotary joint 74 or 74′. Since all four cylinders 68 and 68′ are supplied from one source of pressure, i.e. the feed line 20, then all of the rods 70 and 70′ develop the same force against their respective brackets 72 and 72. The brackets 72 and 72′ each hold a wheel 76 or 76′, respectively, for friction contact against the inner surface 52 of the pipe 12. This action retains the device centered within the pipe. Note that the wheel shown in the upper left of FIG. 1 is designated 48 (because it is a drive wheel) and is designated 76 (because it is a centering wheel, as well). The centering of the device is also assured by a set of parallel mounting arms 80 and 80′, as shown.

As shown in FIG. 1, the apparatus preferably includes two sets of mutually opposed wheels 76 and 76′. Wheel 48 is a drive wheel, while the remainder of the wheels are free wheeling. However, for very steep inclining pipe, the friction of the drive wheel 48 against the interior surface 52 of the pipe 12 may not be adequate to drive the apparatus. Thus, the apparatus may include a support cable 82, such as a wireline. Alternatively, a support cable 82′ may be used to support the apparatus on the opposite end from the support cable 82. The support cable is not intended to provide axial motion to the apparatus; rather, it supports the weight of the apparatus when the apparatus is working with a pipe that is not level, while axial motion of the apparatus is provided by the drive wheel 48.

As previously described, the apparatus preferably includes air motors attached to the wheels, rather than the air motor 34 at the forward end of the apparatus. For steeper inclines of the pipe, more air motors may be required. For example, in the certain applications, four air motors attached to four of eight wheel sets may be required. Elsewhere; one air motor coupled to each wheel set may be called for. The required torque and power to turn the water jet arms is negligible in comparison to the required torque on the wheels. Only one of the drive motors supplies a fraction of its power to drive the water jet arms. The individual air motors are synchronized via the wheels on the pipe wall.

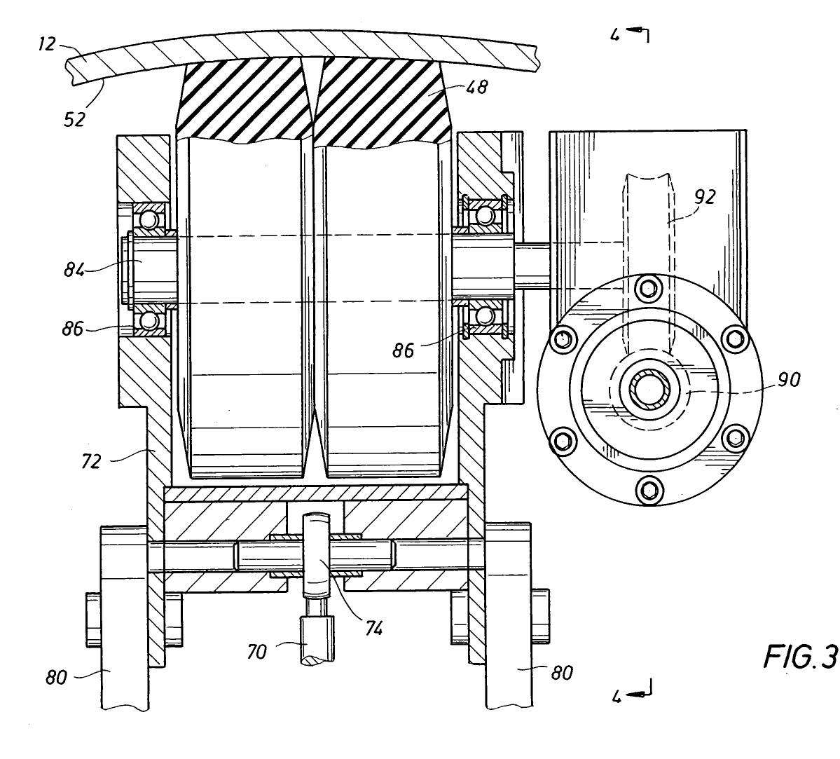

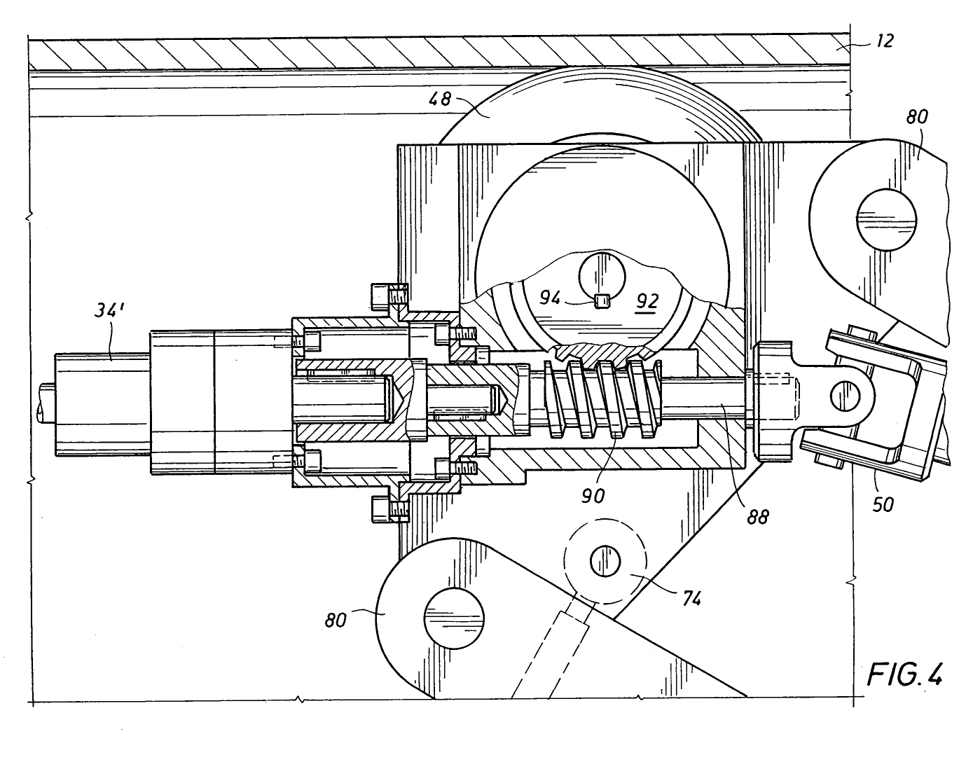

FIGS. 3 and 4 illustrate a preferred arrangement of the drive wheel 48 and associated structure. The drive wheel 48 is preferably formed of a polymeric material that may be compressed against the interior surface 52 of the pipe 12. The drive wheel 48 is supported on the bracket 72 with an axle 84 supported on bearings 86. The bracket is coupled to the rod 70 by the rotary joint 74, as previously described.

The second drive shaft 46 (FIG. 1) terminates at the flexible U-joint 50. The U-joint 50 joins to a shaft 88 which includes a worm gear 90. The worm gear 90 meshes with and drives a worm wheel 92 which is keyed to the drive wheel 48 with a key 94, so that they move as one. Thus, the drive wheel rotates at a speed that is determined only by the rate of air motor 34 and the gear ratio between them.

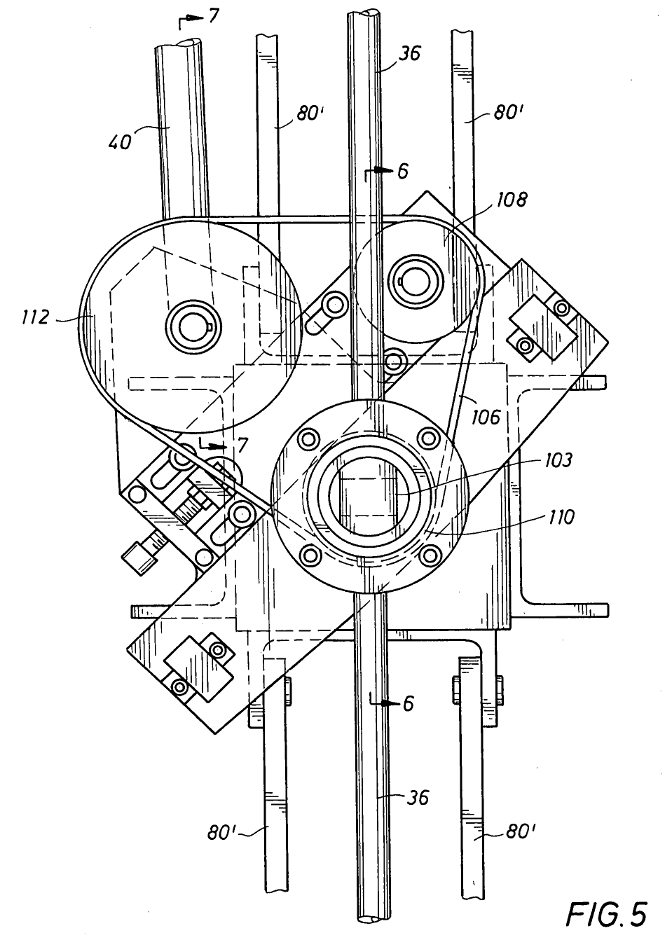

FIGS. 5, 6, and 7 illustrate a preferred structure for the spray arm portion of the apparatus. FIG. 5 shows an end view taken along sight lines 5-5 of FIG. 1. The air motor (FIG. 1) is geared to a drive wheel 108 which drives a drive belt 106. The drive belt extends over a pulley 110 which rotates the spray arms 36. The drive belt 106 also extends over a pulley 112 to drive the first drive shaft 40. Thus, the speed of rotation of the spray arms and the speed of rotation of the first drive shaft are automatically and mechanically synchronized. The pulleys 110 and 112 may be changed out to change the relative speeds, however.

Preferably, with air motors installed at the wheels, rather than at the drive belt, wheel 108 is a tensioning pulley and 112 is the drive wheel for the belt drive unit.

As shown in FIG. 6, the high pressure water feed tube 16 feeds into the apparatus at the high pressure stationary coupling 18. The coupling 18 provides high pressure cleaning fluid, preferably water, to a rotating hollow shaft 120, which is supported at its after end by a bearing 122. The high pressure cleaning fluid is conducted through a conduit 124 within the hollow shaft 120 and then into the spray arms 36. As shown, the spray arms are rotated by the belt 106 driving the pulley 110.

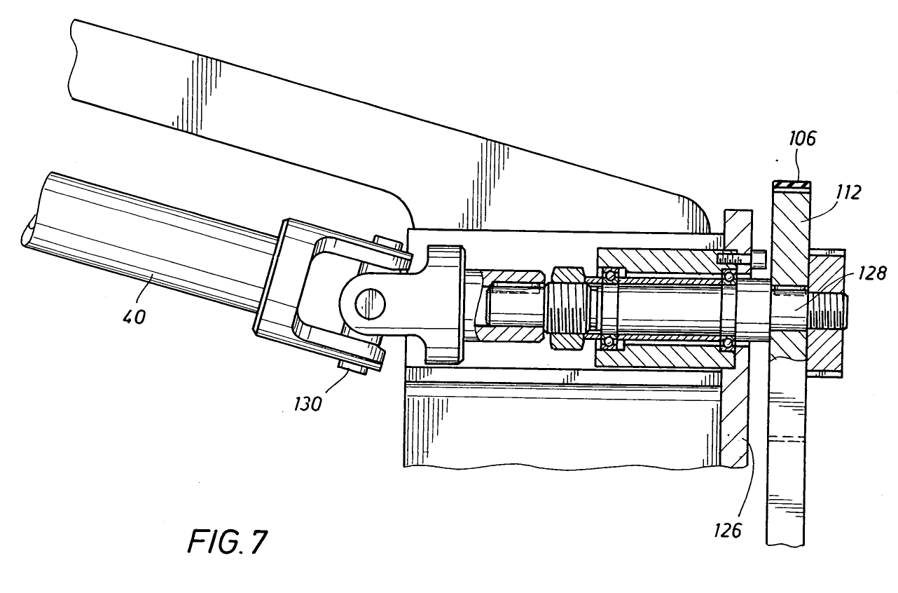

As shown in FIG. 7, the pulley 112 is driven by the belt 106. The pulley 112 is supported on a bracket 126 and is mounted onto an axle 128. At the opposite end of the axle 128, a U-joint 130 couples the axle to the first drive shaft 40. In the preferred alternative embodiment, wheel 112 is driven by the shaft 128, which in turn is driven by shaft 40. The belt drives all other pulleys.

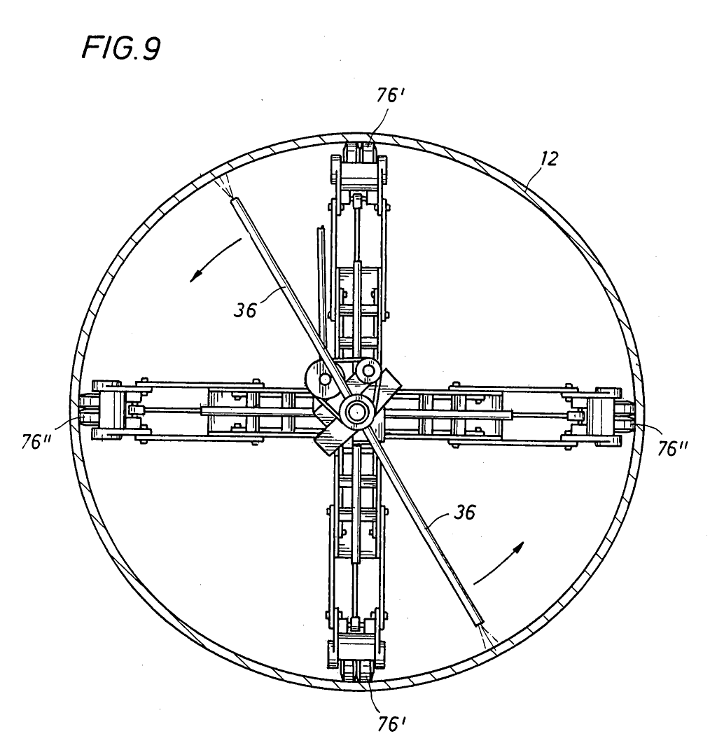

Finally, FIG. 9 illustrates that more than the two pairs of wheels and support arms may be used, if desired. This is illustrated by wheels 76′, as previously shown, with additional wheels 76″ disposed perpendicularly to them. This may provide additional weight bearing structure if necessary for larger apparatus in the largest pipes. This may provide additional driving force with more wheels driven for steep inclines and/or long cleaning runs where larger loads have to be pulled by the apparatus.

It should also be readily apparent to those of skill in the art that, although the apparatus has been described in relation to high pressure cleaning fluid, preferably water, the apparatus could as well be applied to a fine sand or grit for sand blasting, with the same structure as just described. Thus, in the claims to follow, the term “cleaning matter” is to be construed as either a cleaning fluid or sand blasting grit.

When cleaning other than horizontal pipes, the apparatus may be started from the lowest point to be cleaned and then up the pipe with the water jet rotor positioned on the upward side of the apparatus. That way, the wheels will move over cleaned pipe wall. Liners in typical pipes are slippery and friction will be significantly higher after removal of the liner. This results in less load from hydraulic cylinders on the wheels required to achieve the same friction forces. Cleaning from the top down requires extra control of the umbilical to not slide down the pipe. To support the forward (and upward) motion of the machine, the support cable 82 would have to be attached to the swivel joint 103 (See FIG. 6). The swivel joint may also be used as a safety feature in pulling with a force to only keep the support cable taut. Yet, the winch pulling the support cable would permit no backward movement of the machine in normal operation or in case of failure of the machine.

A support cable may be attached to the back side of the machine similar to the support cable 82 as a tension relief feature for the umbilical 14. Skid plates may be clamped to the support cable and in turn secured to the air hoses, the high pressure water hose and video equipment supply cable to the skid plates so each coupling between hose or cable sections would carry only the weight of one hose or cable section below.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

We claim:

1. Cleaning apparatus for cleaning the inside surface of a large diameter pipe, the apparatus comprising:
a feeding tube supplying cleaning matter under pressure;
a nozzle in a cleaning head to receive the cleaning matter from the feeding tube to direct the cleaning matter in a rotating motion to the inside surface of the pipe;
a rotating mechanism for rotating the cleaning head; and
a mechanical coupling automatically synchronizing the driving mechanism and the rotating mechanism.

2. The apparatus of claim 1, further comprising:
a compressed air feeding tube supplying compressed air;
a driving mechanism receiving compressed air from the compressed air feeding tube;

3. The apparatus of claim 1, wherein the cleaning matter is water.

4. The apparatus of claim 1, wherein the cleaning matter is sand blasting grit.

5. The apparatus of claim 1, further comprising:
at least one drive wheel providing friction between the apparatus and the inside surface of the pipe;
at least one idler support wheel riding on the inside surface of the pipe; and
a centering mechanism including at least two hydraulic cylinders providing radial pressure for the at least one drive wheel and the at least one support wheel against the inside surface of the pipe.

6. The apparatus of claim 2, further comprising a plurality of drive wheels coupled to the driving mechanism.

7. The apparatus of claim 2, wherein the driving mechanism includes an air motor.

8. The apparatus of claim 7, wherein the air motor is coupled to the cleaning head for rotating the head and nozzle in a given ratio to the advance movement of the driving wheel.

9. The apparatus of claim 8, further comprising means for changing the ratio of speed of advance to the speed of rotation of the water jet nozzles.

10. The apparatus of claim 1, further comprising opposite wheels in a first plane 90° perpendicular to the axis of the cleaning apparatus for balancing the forces to the cleaning apparatus, when the wheels expand.

11. The apparatus of claim 10, further comprising a second plane perpendicular to the axis of the cleaning apparatus and at a distance to the first plane where opposite wheels according to the first plane are repeated in order to stabilize the centric position of the axis of the cleaning apparatus in the pipe.

12. The apparatus of claim 1, further comprising a support cable adapted to attaching to the apparatus.
